(19) United States
(12) Patent Application Publication
(10) Pub. No.: US 2023/0010637 A1
(43) Pub. Date: Jan. 12, 2023

(54) EPOXIDE-ACTIVATED SUBSTRATES AND HYDROPHOBIC INTERACTION CHROMATOGRAPHY MADE THEREFROM FOR POLYNUCLEOTIDE PURIFICATION

(71) Applicant: DONALDSON COMPANY, INC., BLOOMINGTON, MN (US)

(72) Inventors: JINXIANG ZHOU, GREENVILLE, SC (US); GRAHAM TEMPLES, GREENVILLE, SC (US); BIN GUO, GREENVILLE, SC (US)

(21) Appl. No.: 17/742,956

(22) Filed: May 12, 2022

Related U.S. Application Data
(60) Provisional application No. 63/203,196, filed on Jul. 12, 2021.

(51) Int. Cl. C08L 1/02; C08B 1/00; C08L 79/02; C08B 16/00; C08L 75/08

(52) U.S. Cl. CPC C08L 1/02; C08B 1/003; C08L 79/02; C08B 16/00; C08L 75/08; C08J 2301/02

(57) ABSTRACT

Disclosed are methods for forming an activated membrane that can be further derivatized for use purifying plasmid DNA using hydrophobic interaction separation methods. Activated membrane and derivatized membrane formed by the methods are also described. HIC systems incorporating the derivatized membrane as described herein can exhibit a high plasmid DNA binding capacity and short residence times.

### CROSS REFERENCE TO RELATED APPLICATION

This application claims filing benefit of U.S. Provisional Patent Application Ser. No. 63/203,196, entitled “Epoxide-Activated Surface Preparation and Novel Hydrophobic Interaction Chromatography Membrane Adsorber for Polynucleotide Purification,” having a filing date of Jul. 12, 2021, which is incorporated herein by reference for all purposes.

### FEDERAL RESEARCH STATEMENT

This invention was made with Government support under Grant No. GM125429, awarded by the National Institutes of Health. The Government has certain rights in the invention.

### BACKGROUND

The gene and cell therapy industry has shifted rapidly toward commercial processes due to their promising potential to treat various devastating diseases. Plasmid DNAs (pDNA) are key components in the production of the viral vectors, proteins, and mRNAs that are widely used in gene and cell therapy. There has been a sudden and urgent requirement for high-capacity, high-quality pDNA production. As pDNA is a key component of many products that address the SARS-CoV-2 pandemic, the recent pandemic-related demands have further exacerbated the production challenge. For example, it will require over half of the world's pDNA production capacity to produce one billion mRNA vaccines.

pDNA production has become a bottleneck of the industry as the scale-up of pDNA manufacturing is not straightforward. Currently, qualified contract manufacturers have long waiting lists and substantial backlogs to service the skyrocketing demand. Like many other biologics production schemes, multiple steps and unit operations are involved in pDNA production. Traditionally, downstream purification has been expensive, slow, and difficult to scale. Resin based chromatography columns have been the gold standard employed to purify biologics for decades. Resin columns are known to require long residence times to perform adequately. Moreover, because of the large size of pDNA, resins have low accessible surface area for pDNA binding. Overall, the combination of these factors results in very low productivity for pDNA purification.

Purity of the pDNA is key to follow-on bioprocesses. Beyond removals of RNA, genomic DNA, host cell protein, etc., certain pDNA isoforms are also undesirable. pDNA usually has five isoforms: 1) supercoiled (sc) pDNA; 2) open-circular (oc) pDNA; 3) relaxed circular pDNA; 4) linear pDNA; and 5) supercoiled denatured pDNA. Resin based hydrophobic interaction chromatography (HIC) columns often are used as a critical step to differentiate the desired sc pDNA from other isoforms.

Membrane adsorbers are known to perform well at short column residence times compared to resin columns, resulting in rapid separations for biologics. However, there is currently no known effective commercial HIC membrane adsorber for pDNA purification nor is there any literature reporting high performance HIC membrane adsorbers for pDNA purification.

Sartorius AG produces an HIC membrane product with phenyl groups as HIC ligands; however, it was not designed for pDNA purification. Studies have indicated that this HIC membrane product has a very low pDNA binding capacity (<0.1 mg/mL for 3 k bps pDNA) at 180 seconds residence time. Its binding capacity at higher flowrates (e.g., 36 seconds residence time) will be even lower (less than 0.04 mg/mL for 3 k bps pDNA).

Thus, there remains a need for HIC membrane columns with high binding capacity for pDNA at short residence times. Fulfilling this need would increase downstream pDNA and other polynucleotide purification productivities.

### SUMMARY

In one embodiment, disclosed is a method for forming an epoxy-activated substrate. For instance, a method can include contacting a substrate, e.g., a porous membrane substrate, with an activation solution. The activation solution includes an activation agent, a weak or strong base, and an organic solvent. The activation agent includes a reactive functionality that reacts with a surface of the substrate to form linking groups on the surface of the substrate. The activation agent also includes an epoxy functionality that can remain intact during the activation such that the linking agent includes the epoxy functionality following the activation.

Also disclosed is a method for further derivatizing an activated substrate that includes linking groups at a surface, the linking groups including an epoxy functionality. The method can include contacting the activated substrate with a derivatization solution. The derivatization solution includes a derivatization agent, a base, and optionally, an organic solvent. The derivatization agent includes a functionality that reacts with the epoxy functionality of the linking group. The derivatization agent also includes a hydrophobic portion that includes a hydrophobic ligand. Following the reaction, the hydrophobic ligand is bonded to the substrate surface via the reacted linking group.

Also disclosed is an HIC separation medium that includes a cellulose substrate, e.g., a porous regenerated cellulose substrate, and a hydrophobic ligand bonded to a surface of the cellulose substrate.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a graph showing the dynamic binding capacity (DBC) 10% test results of non-alkaline treated MCP membranes with different activation times.

FIG. 2 is a graph showing the DBC 10% test results of non-alkaline treated MCP membranes with different chemical components.

FIG. 3 is a graph showing the DBC 10% test results of MCP membranes with different alkaline treatments and rinsing steps.

FIG. 4 is an FPLC chromatogram illustrating the loading, washing, and elution phases of a separation. Elution peaks were similar among all the tests. UV260 values and buffer volumes vary from membrane to membrane.

FIG. 5 is a graph showing that binding capacity of the membrane can be improved through pH adjustment of loading buffer.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, should be construed as open-ended as opposed to limiting. Likewise, a group of items linked with the conjunction “and” should not be read as requiring that each and every one of those items be present in the grouping, but rather, should be read as “and/or” unless expressly stated otherwise. Similarly, a group of items linked with the conjunction “or” should not be read as requiring mutual exclusivity among that group, but rather, should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

The present disclosure generally relates to an activated membrane that can be further derivatized for use in one embodiment for purifying pDNA using hydrophobic interaction separation methods. Methods for forming the activated membrane and further derivatization of the activated membrane are also described. In embodiments, a derivatized membrane as described herein can exhibit a high pDNA binding capacity and short residence times.

It is one object of the present disclosure to provide a method of modifying a substrate to include a high density of epoxy-based chemistries, thereby forming an activated membrane.

It is a further object of the present disclosure to provide methods of subsequently derivatizing an activated membrane to incorporate a high density of ligands at a surface of the membrane, and in one particular embodiment, a high density of hydrophobic ligands.

It is a further object of the present disclosure to provide an HIC membrane and a process for forming the HIC membrane for rapid and efficient purification of pDNA and other polynucleotides, such as mRNA, genome DNA, RNA, and DNA, etc.

To form an activated substrate, a substrate can be contacted with an activation solution, the activation solution including at least one epoxy-containing activation agent, one or more bases (e.g., a weak base), and one or more organic solvents.

The substrate can be in the form of a non-porous film, a porous membrane, a nanofiber mat, a monolith (a single, porous three-dimensional structure), a resin (a solid polymeric phase in the form of individual particles, e.g., chips or beads), etc. As utilized herein, the term “membrane” generally refers to a relatively thin sheet material having a porous structure.

In one embodiment, a thin substrate, e.g., a membrane or nanofiber mat, can have a thickness of from about 30 micrometers to about 2500 micrometers. For instance, a thin substrate can have a thickness of greater than about 500 micrometers, greater than about 250 micrometers, greater than about 100 micrometers, greater than about 80 micrometers, greater than about 50 micrometers, or greater than about 30 micrometers, such as from about 30 micrometers to about 500 micrometers, from about 50 micrometers to about 500 micrometers, from about 80 micrometers to about 500 micrometers, from about 100 micrometers to about 500 micrometers, from about 250 micrometers to about 500 micrometers, from about 30 micrometers to about 250 micrometers, from about 50 micrometers to about 250 micrometers, from about 80 micrometers to about 250 micrometers, from about 100 micrometers to about 2500 micrometers, from about 30 micrometers to about 100 micrometers, from about 50 micrometers to about 100 micrometers, or from about 80 micrometers to about 100 micrometers.

In some embodiments, a substrate can be a porous membrane substrate that can be a supported membrane, e.g., a laminate including a porous membrane adjacent (e.g., adhered or attached) to a supporting frame or backing material that exhibits a greater porosity than the porous membrane substrate. In some embodiments, a porous membrane substrate can be a self-supporting membrane, i.e., not requiring a backing material. Of course, an otherwise self-supporting membrane can be retained by a support, if desired. Porous membrane substrates as described herein encompass membranes prepared by casting, coating, or forming including, but not limited to, porous hydrogel membranes as well as fibrous membranes, e.g., porous membranes formed of nanofibers, such as electrospun nanofibers.

The substrate can have a relatively high surface area, e.g., a porous substrate having a specific surface area of from about 0.1 m²/mL to about 30 m²/mL, such as from about 0.1 m²/mL to about 25 m²/mL, from about 0.1 m²/mL to about 20 m²/mL, from about 0.1 m²/mL to about 15 m²/mL, from about 0.1 m²/mL to about 10 m²/mL, from about 0.5 m²/mL to about 30 m²/mL, from about 0.5 m²/mL to about 25 m²/mL, from about 0.5 m²/mL to about 20 m²/mL, from about 0.5 m²/mL to about 15 m²/mL, from about 0.5 m²/mL to about 10 m²/mL, from about 0.5 m²/mL to about 5 m²/mL, from about 1 m²/mL to about 30 m²/mL, from about 1 m²/mL to about 25 m²/mL, from about 1 m²/mL to about 20 m²/mL, from about 1 m²/mL to about 15 m²/mL, from about 1 m²/mL to about 10 m²/mL, from about 1 m²/mL to about 5 m²/mL, from about 5 m²/mL to about 30 m²/mL, from about 5 m²/mL to about 25 m²/mL, from about 5 m²/mL to about 20 m²/mL, from about 5 m²/mL to about 15 m²/mL, or from about 5 m²/mL to about 10 m²/mL. In some embodiments, a porous substrate can be a macroporous substrate, e.g., a macroporous membrane substrate. In general, a macroporous substrate can include a specific surface area of about 1 m²/mL or greater, such as from about 1 m²/mL to about 30 m²/mL, from about 1 m²/mL to about 25 m²/mL, from about 1 m²/mL to about 20 m²/mL, from about 1 m²/mL to about 15 m²/mL, from about 1 m²/mL to about 10 m²/mL, from about 1 m²/mL to about 5 m²/mL, from about 5 m²/mL to about 30 m²/mL, from about 5 m²/mL to about 25 m²/mL, from about 5 m²/mL to about 20 m²/mL, from about 5 m²/mL to about 15 m²/mL, or from about 5 m²/mL to about 10 m²/mL. In one embodiment, macroporous membrane substrates can exhibit high volumetric flow rates without high pressure.

In those embodiments in which the substrate is porous, the porous substrate can generally have a pore size from about 0.1 micrometer to about 10 micrometers. For instance, a porous substrate, e.g., a porous membrane substrate, can exhibit a pore size of from about 0.1 micrometer to about 0.2 micrometers, from about 0.1 micrometer to about 0.45 micrometers, from about 0.1 micrometer to about 1 micrometer, from about 0.1 micrometer to about 2 micrometers, from about 0.2 micrometer to about 0.45 micrometers, from about 0.2 micrometers to about 1 micrometer, from about 0.2 micrometer to about 2 micrometers, from about 0.2 micrometer to about 10 micrometers, from about 0.45 micrometer to about 1 micrometer, from about 0.45 micrometers to about 2 micrometers, from about 0.45 micrometer to about 10 micrometers, from about 1 micrometer to about 2 micrometers, or from about 1 micrometer to about 5 micrometers.

In one embodiment, the substrate can be formed from a hydrophilic material such as cellulose, cellulose derivatives, regenerated cellulose, nylon, or other hydrophilic materials. However, it is to be understood that the use of a hydrophilic material is not required, and the substrate can be formed from other materials known to those of ordinary skill in the art, such as a polysulfone, a polyether sulfone, a polyvinylidene fluoride, a polyacrylonitrile, a polyetherimide, a polypropylene, a polyethylene, a polyether terephthalate, etc., or any combination of materials.

To form an activated substrate, a substrate, e.g., a porous membrane substrate, can be contacted with an activation solution. In one embodiment, the substrate can be contacted by immersing the substrate in the activation solution. The activation solution can include an activation agent in addition to at least one base and at least one organic solvent. Upon the immersion, interaction between a reactive functionality of the activation agent and a surface of the substrate can form activated linker groups on the surface, each linker group including at least one reactive epoxy group.

The activation agent can be a multi-functional agent, e.g., bi-functional, tri-functional, etc., in which at least one functional group of the agent is configured to react with a surface of the substrate and at least one functional group is an epoxy that will not react during the activation step, i.e., an epoxy group that will remain active following the activation step. As such, upon the reaction between the activation agent and the substrate, an epoxy-containing linking group can be at the surface of the activated substrate.

The active agent can include, without limitation, an epichlorohydrin, a diglycidyl ether, triglycidyl ether, tetraglycidyl ether, or any combination thereof.

In embodiments, the concentration of the activation agent in the solvent can range from about 0.1% (V/V) to about 60% (V/V) of the solution, such as from about 2% (V/V) to about 40% (V/V) of the solution, or from about 5% (V/V) to about 30% (V/V) of the solution.

The organic solvent component of an activation solution can be selected from, but is not limited to, a single organic solvent, an aqueous/organic solvent mixture, or a mixture of organic solvents. When considering an activation solution that includes water, the water will generally be present in an amount of about 50% (V/V) or less by volume of the activation solution, e.g., about 40% (V/V) or less, about 30% (V/V) or less, about 20% or less, about 10% (V/V) or less, or about 5% (V/V) or less in some embodiments.

In one embodiment, an organic solvent component can include a protic solvent. Without wishing to be held to any particular theory, it is understood that inclusion of one or more protic solvents in an activation solution can promote SN1 reactions. Protic solvents can be selected from a group including, but not limited to, an alcohol (e.g., ethanol, methanol, propanol (1-propanol, 2-propanol, isopropanol), butanol (n-butanol), etc.), nitromethane, or any combination thereof. In one embodiment, a protic solvent can include a combination of an alcohol (e.g., ethanol) with water.

In one embodiment, an organic solvent can include an aprotic solvent. Without wishing to be held to any particular theory, it is understood that inclusion of one or more aprotic solvents in an activation solution can promote SN2 reactions. Aprotic solvents can be selected from a group including, but not limited to, dimethyl sulfoxide, dimethyl formamide, N-methylpyrrolidinone, etc.

The concentration of one or more organic solvents in an activation solution can range from about 1% (V/V) to about 99% (V/V) of the activation solution, in some embodiments, such as from about 10% (V/V) to about 95% (V/V) of the activation solution or from about 5% (V/V) to about 30% (V/V) of the activation solution, in some embodiments.

The activation solution can also include a base. In some embodiments, the base can be a weak base. As utilized herein, the term “weak base” generally refers to a base that does not completely dissociate in water. The weak base of an activation solution can include, without limitation, an alkanamine (e.g., methylamine, triethylamine, trimethylamine, tripropylamine, tributylamine, etc.), a pyridine, an imidazole, a benzimidazole, a histidine, a guanidine, a phosphazene base, N,N-dimethylbenzyl amine, 3-dimethylaminopropyl amine, N,N-diisopropylethylamine, N,N-dimethylene diamine, diethylamine, or any combination thereof. A strong base can optionally be utilized in the base component of the activation solution. A strong base can include, without limitation, sodium amide, sodium hydroxide, lithium bis(trimethylsilyl)amide, lithium tert-butoxide or any combination thereof.

In one embodiment, a weak base can be present in an activation solution at a concentration in a range from about 0.1% (V/V) to about 50% (V/V) of the activation solution, such as from about 1% (V/V) to about 30% (V/V) of the activation solution, or from about 3% (V/V) to about 20% (V/V) of the activation solution, in some embodiments. In some embodiments, the concentration of the weak base in the organic solvent component of the activation solution can range from about 0.01 M to about 5 M, in some embodiments, such as from about 0.5 M to about 4 M, or from about 0.1 M to about 1 M.

When utilized, a strong base can be in the activation solution at a concentration in a range from about 0.01% (V/V) to about 10% (V/V) of the activation solution, such as from about 0.01% (V/V) to about 5% (V/V) of the activation solution, or from about 0.01% (V/V) to about 3% (V/V) of the activation solution, in some embodiments. In some embodiments, the concentration of a strong base in the organic solvent component of the activation solution can range from about 0.01 M to about 0.5 M, in some embodiments, such as from about 0.01 M to about 0.2 M, or from about 0.02 M to about 0.1 M.

To carry out the activation of the substrate, the substrate can be continuously contacted with (e.g., immersed in) the activation solution for a period of time. Optionally, the activation solution can be cooled or heated prior to/during the contact. For instance, the activation step can be carried out with the activation solution held at a temperature ranging from about 0° C. to about 100° C., for instance, at a temperature ranging from about 10° C. to about 90° C., from about 20° C. to about 90° C., from about 20° C. to about 80° C., from about 20° C. to about 70° C., from about 20° C. to about 60° C., from about 30° C. to about 90° C., from about 30° C. to about 80° C., from about 30° C. to about 70° C., from about 30° C. to about 60° C., from about 30° C. to about 50° C., or at a temperature of about 40° C., in some embodiments. In some embodiments, the activation step can be carried out in darkness, e.g., in a darkened room with little or no visible light.

In one embodiment, a substrate can be subjected to a pretreatment prior to contact with the activation solution. For instance, a substrate can be pretreated by contact with an alkaline solution. When included, such a pretreatment can include contacting a substrate with an alkaline solution that includes at least one base and at least one protic solvent. A base can include, without limitation, sodium hydroxide, potassium hydroxide, potassium carbonate, potassium bicarbonate, sodium carbonate, sodium bicarbonate, tris base, etc., or any combination thereof. A protic solvent can include, without limitation, an alcohol (e.g., ethanol, methanol, propanol (1-propanol, 2-propanol, isopropanol), butanol (n-butanol), etc.), nitromethane, water, or any combination thereof.

When included, an alkaline pretreatment step can generally be carried out a temperature ranging from about 0° C. to about 80° C., for instance, at a temperature ranging from about 10° C. to about 70° C., about 25° C., or at room temperature, in some embodiments. As stated, an alkaline pretreatment is not required in forming an activated substrate.

Once formed, an activated substrate can be further derivatized via the epoxy-containing linking groups. Beneficially, an activated substrate (e.g., an activated membrane substrate) may not need to be dried following activation. However, in other embodiments, an activated membrane can be dried, stored, and/or transported prior to further derivatization.

To further derivatize an activated substrate, a substrate can be contacted (e.g., immersed) in a derivatization solution. A derivatization solution can include an organic solvent, a base, and a derivatization agent. In one embodiment, a derivatization agent can include hydrophobic portion that, upon reaction of the derivatization agent with the linking agent of the substrate, can provide a hydrophobic ligand on a surface of the substrate.

The derivatization agent of the solution can include an epoxy-reactive functionality configured for reaction with an epoxy of the activated substrate and at least one hydrophobic portion that will remain bonded at the substrate surface via the linking agent following reaction as a hydrophobic ligand on a surface of the substrate. For instance, the epoxy-reactive functionality can include, without limitation, a primary or secondary amine, a thioether, an epoxide, a carboxylic acid, an organohalide, etc.

The hydrophobic portion of the derivatization agent can include the hydrophobic ligand. Examples of hydrophobic ligands as may be incorporated on an activated substrate can include, without limitation, aliphatic chains with two or more carbons (e.g., butyl, pentyl, hexyl, septyl, octyl, nonyl, decyl, undecyl, dodecyl), benzyl-containing groups, phenyl-containing groups, phenol-containing groups, pyridine-containing groups, boronic acid groups, branched polymers (e.g., polypropylene glycol), sulfur containing thiophilic groups (e.g., propanethiol, 2-butanethiol, 3,6-dioxa-1,8-octanedithiol, octanethiol, benzyl mercaptan, 2-mercaptopyridine, thiophenol, 1,2-ethanedithiol, 1,4-benzenedimethanethiol, 2-phenylethanethiol), etc., as well as any combination thereof.

Hydrophobic ligands as may be a component of a derivatization agent and attached to a substrate via reaction of the derivatization agent with an epoxy of the linking agent can be selected from ligands that follow the hydrophobic effect for hydrophobic interaction ligands; pi-pi stacking between immobilized aromatics and the aromatic rings in the nucleobase for aromatic containing ligands; or with electron donation/charge transfer for ligands that contain thioethers; or a combination thereof.

In one embodiment, a hydrophobic ligand of a derivatization agent can exhibit an affinity to plasm ids and other polynucleotides.

The hydrophobic portion of a derivatization agent is not limited to the above-exemplified hydrophobic ligands, and alternative ligands can be incorporated on an activated substrate as described herein.

Examples of derivatization agents can include, but are not limited to, thiophenol, 2-butanethiol, furfurylthiol, 6-mercaptopurine, 2-mercapto-benzothiazole, propanethiol, cyclopentanethiol, o-mercaptobenzoic acid, dithiothreitol, 1,2-ethanedithiol, 3,6-dioxa-1,8-octanedithiol, 1,4-benzenedimethanethiol, 1,3-benzenedimethanethio, 1,2-benzenedimethanethio, 4,4′-bis(mercaptomethyl)biphenyl, 2,4-dichlorobenzylmercaptan, 4-methoxybenzylmercaptan, triphenylmethanethiol, 2,4-dimethoxythiophenol, or any combination thereof.

In one embodiment, the concentration of the derivatization agent in the derivatization solution can range from about 0.01% (W/V) to about 5% (W/V) of the derivatization solution, such as from about 0.03% (V/V) to about 3% (V/V) of the derivatization solution or from about 0.05% (V/V) to about 1% (V/V) of the derivatization solution, in some embodiments.

The base of the derivatization solution can be the same or can differ from the base of an activation solution. For instance, a base can include, without limitation, an alkanamine (e.g., methylamine, triethylamine, trimethylamine, tripropylamine, tributylamine, etc.), a pyridine, an imidazole, a benzimidazole, a histidine, a guanidine, a phosphazene base, N,N-dimethylbenzyl amine, 3-dimethylaminopropyl amine, N,N-diisopropylethylamine, N,N-dimethylene diamine, diethylamine, sodium amide, sodium hydroxide, sodium carbonate, sodium bicarbonate, potassium hydroxide, potassium carbonate, potassium bicarbonate, or any combination thereof.

In one embodiment, the concentration of the base in a derivatization solution can range from about 0.01% (V/V) of the derivatization solution to about 99% (V/V) of the derivatization solution, such as from about 0.1% (V/V) of the derivatization solution to about 50% (V/V) of the derivatization solution, or from about 0.5% (V/V) of the derivatization solution to about 30% (V/V) of the derivatization solution, in some embodiments.

The organic solvent component of a derivatization solution can be the same or can differ from an organic solvent component of an activation solution. For instance, an organic solvent of a derivatization solution can include, without limitation, an alcohol (e.g., ethanol, methanol, propanol (1-propanol, 2-propanol, isopropanol)), dimethyl sulfoxide, dimethyl formamide, N-methylpyrrolidinone, nitromethane, or any combination thereof.

The concentration of the organic solvent component of a derivatization solution can range from about 0% (V/V) of the derivatization to about 99% (V/V) of the derivatization solution, such as from about 10% (V/V) of the derivatization solution to about 90% (V/V) of the derivatization solution, or from about 20% (V/V) of the derivatization solution to about 85% (V/V) of the derivatization solution, in some embodiments.

To carry out a derivatization of the activated substrate, the substrate can be continuously contacted with (e.g., immersed in) the derivatization solution for a period of time. Optionally, the derivatization solution can be cooled or heated prior to/during the contact. For instance, the derivatization step can be carried out with the derivatization solution a temperature ranging from about 0° C. to about 80° C., such as at a temperature ranging from about 20° C. to about 60° C. or about 30° C. in some embodiments.

The time of contact for the derivatization step can vary. In some embodiments, the derivatization reaction time ranges from 1 minute to 48 hours. In some embodiments, the derivatization reaction time ranges from 0.5 hour to 24 hours. In some embodiments, the derivatization reaction time ranges from 1 hour to 24 hours. In some embodiments, the derivatization reaction time ranges from 0.5 hour to 16 hours. In some embodiments, the derivatization reaction time ranges from 0.5 hour to 4 hours. In some embodiments, the derivatization reaction time ranges from 4 hours to 16 hours.

In one embodiment, a derivatized substrate can be further processed for use. For instance, a derivatized substrate can be processed (e.g., shaped, stacked, combined, retained, etc.) to form a derivatized separation medium for use in an HIC protocol. In one embodiment, a derivatized separation medium can be formed from one or more derivatized membranes, for instance, a plurality of derivatized membranes that can be stacked and/or shaped as desired to form a separation medium for use in an HIC protocol.

By way of example, multiple derivatized membrane substrates can be stacked to form a multi-layer arrangement to increase capacity for a given application. In one embodiment, a stacked arrangement of derivatized membranes can have a thickness of about 70 micrometers to about 10,000 micrometers, such as about 10,000 micrometers or greater, about 7,500 micrometers or greater, about 5,000 micrometers or greater, about 2,500 micrometers or greater, about 1,000 micrometers or greater, about 900 micrometers or greater, about 800 micrometers or greater, about 700 micrometers or greater, about 600 micrometers or greater, about 500 micrometers or greater, about 400 micrometers or greater, about 300 micrometers or greater, about 200 micrometers or greater, about 100 micrometers or greater, about 70 micrometers or greater, such as about 70 micrometers to about 100 micrometers, about 70 micrometers to about 200 micrometers, about 70 micrometers to about 300 micrometers, about 70 micrometers to about 400 micrometers, about 70 micrometers to about 500 micrometers, about 70 micrometers to about 750 micrometers, about 70 micrometers to about 1,000 micrometers, about 70 micrometers to about 2,000 micrometers, about 70 micrometers to about 3,000 micrometers, about 70 micrometers to about 4,000 micrometers, about 70 micrometers to about 5,000 micrometers, about 250 micrometers to about 300 micrometers, about 250 micrometers to about 400 micrometers, about 250 micrometers to about 500 micrometers, about 250 micrometers to about 750 micrometers, about 250 micrometers to about 1,000 micrometers, about 250 micrometers to about 2,000 micrometers, about 250 micrometers to about 3,000 micrometers, about 250 micrometers to about 4,000 micrometers, about 250 micrometers to about 5,000 micrometers, about 500 micrometers to about 1,000 micrometers, about 500 micrometers to about 2,000 micrometers, about 500 micrometers to about 3,000 micrometers, about 500 micrometers to about 4,000 micrometers, or about 500 micrometers to about 5,000 micrometers.

Flow rates of separation media disclosed herein can be, for example, from about 0.5 column volumes (CV)/min to about 1000 CV/min, from about 1 CV/min to about 1000 CV/min, from about 2 CV/min to about 1000 CV/min, from about 3 CV/min to about 1000 CV/min, from about 4 CV/min to about 1000 CV/min, from about 5 CV/min to about 1000 CV/min, from about 6 CV/min to about 1000 CV/min, from about 0.5 CV/min to about 500 CV/min, from about 1 CV/min to about 500 CV/min, from about 2 CV/min to about 500 CV/min, from about 3 CV/min to about 500 CV/min, from about 4 CV/min to about 500 CV/min, from about 5 CV/min to about 500 CV/min, from about 6 CV/min to about 500 CV/min, from about 0.5 CV/min to about 100 CV/min, from about 1 CV/min to about 100 CV/min, from about 2 CV/min to about 100 CV/min, from about 3 CV/min to about 100 CV/min, from about 4 CV/min to about 100 CV/min, from about 5 CV/min to about 100 CV/min, from about 6 CV/min to about 100 CV/min, from about 0.5 CV/min to about 50 CV/min, from about 1 CV/min to about 50 CV/min, from about 2 CV/min to about 50 CV/min, from about 3 CV/min to about 50 CV/min, from about 4 CV/min to about 50 CV/min, from about 5 CV/min to about 50 CV/min, or from about 6 CV/min to about 50 CV/min.

In one embodiment, a separation medium can be utilized for purifying pDNA and other polynucleotides, such as mRNA, genome DNA, RNA, and DNA, etc., rapidly and efficiently using an HIC separation media at a fast flow rate. For instance, a polynucleotide purification method utilizing separation media as disclosed herein can provide a higher than 80% recovery of targeted materials having a purity of about 80% or greater. Moreover, a separation medium (e.g., single or multiple derivatized substrates combined together) can have a dynamic pDNA binding capacity greater than 1 mg pDNA/mL membrane at residence time shorter than 120 seconds.

Separation systems incorporating separation media as described herein can include separation columns as known in the art. By way of example, separation columns encompassed herein can include, without limitation, syringe filter columns, spin columns, cassettes, and spiral-wound membrane columns as are generally known.

In one particular embodiment, an HIC membrane-based column as described herein can be used in separation and purification of pDNA and other polynucleotides, such as mRNA, genomic DNA, RNA, and DNA, etc. In one embodiment, an HIC separation column can operate in a bind-and-elute mode.

Separation systems as disclosed can exhibit high process productivity. Process productivity of a column can be defined using the equation below. In the denominator, Vₜₒₜ is the total volume of solution passing through the column during the whole process, including load, rinse, elution, and regeneration steps. BV is the HIC medium bed volume, and τ is residence time. Loading volume is proportional to dynamic binding capacity of the HIC medium. Thus, process productivity increases with increasing binding capacity and decreasing residence time.

$$Productivity = \frac{Polynucleotides captured}{Cost of time} = \frac{Loading volume \times polynucleotides concentration \times yield}{( \frac{{V}_{tot}}{BV} ) \times τ}$$

In embodiments, disclosed separation systems can provide a dynamic binding capacity of from about 1 to about 5 mg pDNA per mL media, such as from about 1 to about 10, about 1 to about 20, about 1 to about 25, about 1 to about 30, about 2 to about 5, about 2 to about 10, about 2 to about 15, about 2 to about 20, about 2 to about 25, about 2 to about 30, about 3 to about 5, about 3 to about 10, about 3 to about 15, about 3 to about 20, about 3 to about 25, about 3 to about 30, about 4 to about 5, about 4 to about 10, about 4 to about 15, about 4 to about 20, about 4 to about 25, about 4 to about 30, about 5 to about 10, about 5 to about 15, about 5 to about 20, about 5 to about 25, or about 5 to about 30 mg pDNA/mL membrane, e.g., at a residence time shorter than 120 seconds.

Known commercial HIC column products operate at a residence time of 180 seconds, with a dynamic binding capacity of less than 0.1 mg/mL for 3 k bps pDNA. For two media with the same dynamic binding capacity that achieve the same product yield, the ratio of load productivities can be estimated by the inverse ratio of residence times. Thus, in one embodiment, compared to separation media including a derivatized membrane as described in the present disclosure having a 4 mg/mL dynamic binding capacity at about 2 seconds or less residence time, the load productivity of separation media herein described can be 3600 times (=4/0.1×180 s/2 s) that of currently known commercial HIC column products for plasmid purification. There are no known column products currently available that approach such productivity as achieved by the present invention.

The present disclosure may be better understood with reference to the examples, provided below.

In all figures of the Examples, a dynamic binding capacity at 10% breakthrough (DBC_{10%}) represents the mass bound per unit volume of membrane bed when the sorptive concentration in the effluent from the membrane bed reached 10% of the feed. To form the columns of the Examples, two layers of 24 mm circular HIC membrane disks were packed into a plastic prototype mini column (membrane volume=0.055 mL) to measure DBC_{10%} values. The tests were conducted using Fast Protein Liquid chromatography (AKTA™ pure 25, Cytiva). Plasmid (pRP[Exp]-CMV>EGFP, 3657 bp) was purified using Qiagen® Mega Kit (Cat. No. 12281) and diluted to a concentration of 11-13 μg/mL. 3 M ammonium sulfate in 40 mM Tris-HCl, pH 8 was used as loading buffer.

### EXAMPLE 1

Activation: A 10×60 cm regenerated cellulose membrane sheet with a nominal pore size of 1 μm was activated by soaking it in a solution containing 9.2% (v/v) epichlorohydrin (EPI), 5.4% (v/v) triethylamine (TEA) and 85.4% (v/v) ethanol (EtOH). The reaction was performed with overnight shaking at 120 rpm at room temperature in darkness. After 20-24 hours, the membrane was rinsed with EtOH for five minutes followed by two, five-minute acetone rinses. Subsequently, the membrane sheet was dried at room temperature.

MCP incorporation: The activated membrane was treated with 82 mM 2-mercaptopyridine (MCP) dissolved in a solution containing 80.7% (v/v) methanol, 8.6% (v/v) deionized (DI) water, 9.6% (v/v) 5 M sodium hydroxide (NaOH), and 1.1% (v/v) TEA. The reaction was performed with overnight shaking at 100 rpm at room temperature in darkness. After 20-24 hours, the membrane was rinsed with ethanol for five minutes followed by two, five-minute acetone rinses. Subsequently, the membrane sheet was dried at room temperature.

### EXAMPLE 2

Activation: Three epichlorohydrin activated membranes were prepared in the same manner as described in Example 1, except three reaction times were applied: 1-hour reaction time for membrane 1; 3-hour reaction time for membrane 2; and overnight (20-24 hours)-reaction time for membrane 3. Reactions were performed on a shaker at 120 rpm and room temperature in darkness. After reaction, membranes were rinsed and dried following the same procedure as described in Example 1.

MCP incorporation: Dried activated membranes were derivatized in the same manner as in Example 1.

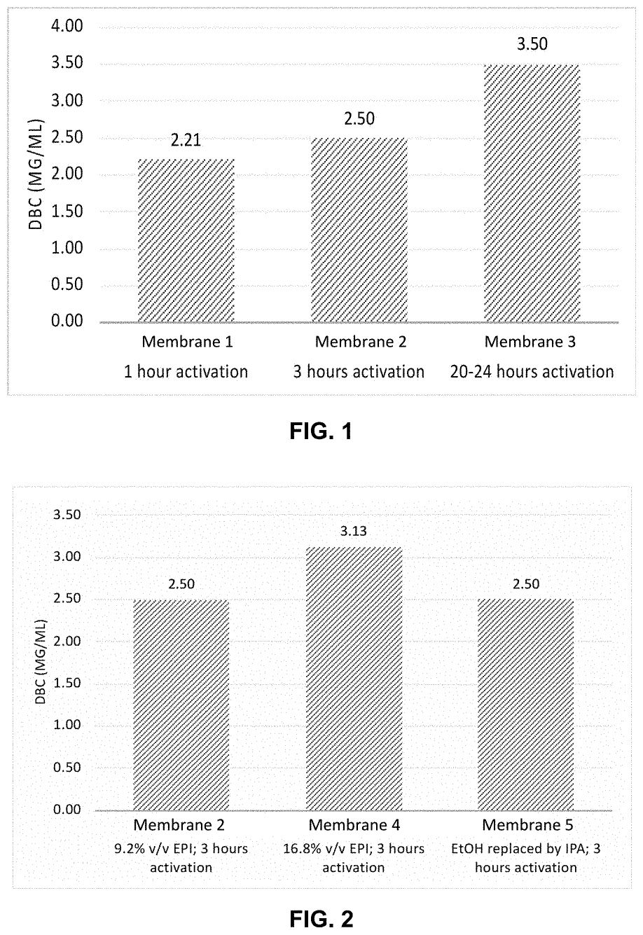

FIG. 1 shows that the HIC membrane binding capacity in terms of DBC_{10%} increased with the extended reaction time. For the same activation solution and the same incorporation processes, 20-24 hours reaction time brought a 58% increase of binding capacity.

### EXAMPLE 3

Activation: Two epichlorohydrin activated membranes were prepared in the same manner as in Example 1 with 3-hour activation time (membrane 2). However, two changes were applied to the formula: 1) membrane 4 was soaked in activation solution with double EPI concentration of 16.8% v/v; and 2) membrane 5 was soaked in activation solution with EtOH replaced by the same amount of 2-propanol (IPA).

MCP incorporation: Dried activated membranes were derivatized in the same manner as in Example 1.

As shown in FIG. 2, double EPI concentration resulted in an 25% increase of binding capacity. Also, the replacement of EtOH by IPA caused little or no change in binding capacity, which indicates that IPA can be used to replace EtOH to make said membranes in some situations, especially for some cost-effective processes.

### EXAMPLE 4

Alkaline treatment: Three membrane strips and two alkaline treatments were used: Set 1) membrane 11 was soaked in 0.3 M NaOH dissolved in 100% EtOH for 30 minutes on a shaker at 80 rpm and room temperature. 0.3 M NaOH in 100% EtOH was prepared and filtered in the same manner as in Example 4; and Set 2) membranes 12 and 13 were soaked in 0.1 M NaOH dissolved in DI for 30 minutes on a shaker at 80 rpm and room temperature.

Membrane 12 was rinsed with 200 mM Tris pH 7. Subsequently, the membrane was dried at room temperature.

Meanwhile, membranes 10 and 13 were rinsed with 200 mM Tris pH 7. Subsequently, membranes 10 and 13 were transferred to activation solution.

Activation: Membranes 11 and 12 were rinsed with EtOH and acetone in the same manner as in Example 1, while membranes 10 and 13 were rinsed with EtOH for five minutes followed by twice DI rinses with each one for five minutes. Subsequently, membranes 10 and 13 were transferred to MCP derivatization solution.

MCP incorporation: Membranes were derivatized in the same manner as in Example 1.

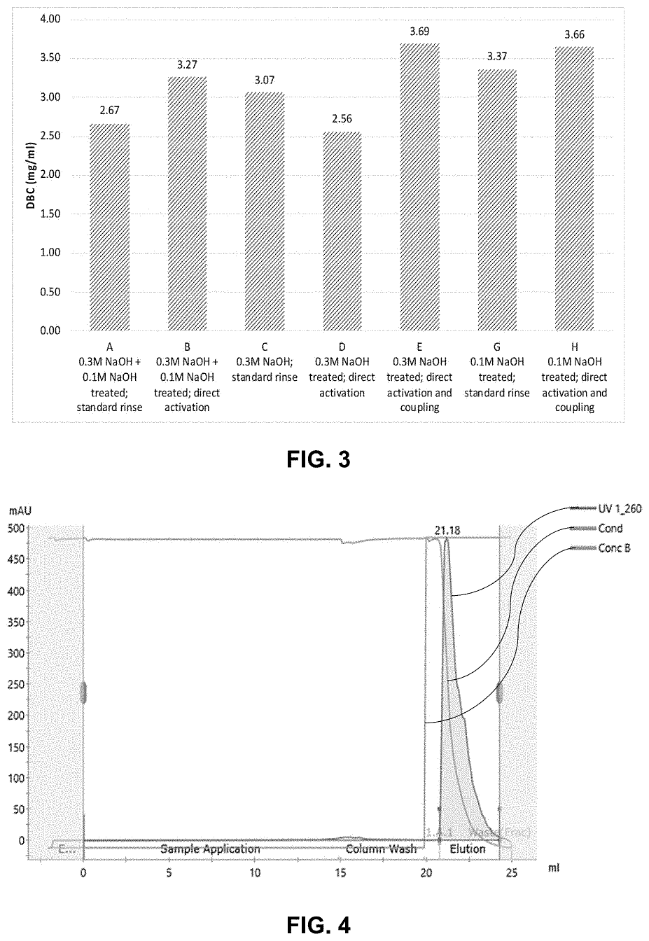

FIG. 3 shows that membranes prepared with rinsing steps had higher binding capacities than membranes prepared with drying steps.

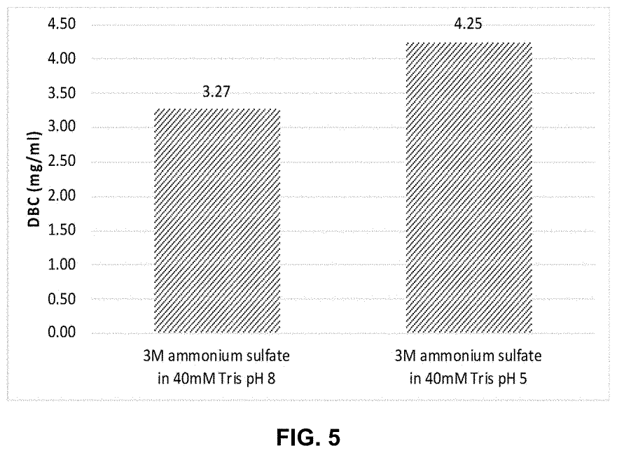

FIG. 4 shows an example chromatogram using sc plasmid DNA as testing reagent.

FIG. 5 shows that a 30% increase of binding capacity was observed when pH of loading buffer decreased from 8 to 5.

While certain embodiments of the disclosed subject matter have been described using specific terms, such description is for illustrative purposes only, and it is to be understood that changes and variations may be made without departing from the spirit or scope of the subject matter.

What is claimed is:

1. A method for forming an activated substrate comprising contacting a substrate with an activation solution, the activation solution comprising an activation agent, a base, and an organic solvent, the activation agent including a reactive functionality configured to react with a surface of the substrate to form a linking group on the surface, the activation agent further including an epoxy group, the linking group comprising the epoxy group.

2. The method of claim 1, the substrate comprising a non-porous film, a porous membrane, a monolith, a nanofiber mat, or a resin.

3. The method of claim 1, wherein the substrate comprises a porosity having a pore size of from about 0.1 micrometers to about 10 micrometers.

4. The method of claim 1, wherein the substrate comprises cellulose, regenerated cellulose, a cellulose derivative, a nylon, a polysulfone, a polyether sulfone, a polyvinylidene fluoride, a polyacrylonitrile, a polyetherimide, a polypropylene, a polyethylene, a polyether terephthalate, or any combination thereof.

5. The method of claim 1, the active agent comprising an epichlorohydrin, a diglycidyl ether, a triglycidyl ether, a tetraglycidyl ether, or any combination thereof.

6. The method of claim 1, the organic solvent comprising a protic organic solvent or an aprotic organic solvent, or a combination thereof.

7. The method of claim 1, the organic solvent comprising an alcohol, nitromethane, dimethyl sulfoxide, dimethyl formamide, N-methylpyrrolidinone, or any combination thereof.

8. The method of claim 1, the base comprising an alkanamine (e.g., methylamine, triethylamine, trimethylamine, tripropylamine, tributylamine, etc.), a pyridine, an imidazole, a benzimidazole, a histidine, a guanidine, a phosphazene base, N,N-dimethylbenzyl amine, 3-dimethylaminopropyl amine, N,N-diisopropylethylamine, N,N-dimethylene diamine, diethylamine, sodium amide, sodium hydroxide, lithium bis(trimethylsilyl)amide, lithium tert-butoxide, or any combination thereof.

9. The method of claim 1, the activation solution comprising the active agent in an amount of from about 0.1% (V/V) to about 60% (V/V) by volume of the organic solvent; the organic solvent in an amount of from about 1% (V/V) to about 99% (V/V) by volume of the activation solution; and the weak base in an amount of from about 0.1% (V/V) to about 50% (V/V) by volume of the activation solution.

10. The method of claim 1, wherein the substrate is contacted with the activation solution at a temperature of from about 0° C. to about 100° C.

11. The method of claim 1, further comprising pretreating the substrate prior to the contact.

12. A method for derivatizing the activated substrate of claim 1, the method comprising contacting the activated substrate with a derivatization solution, the derivatization solution comprising an epoxy-reactive functionality and a hydrophobic portion, the hydrophobic portion comprising a hydrophobic ligand that will remain bonded at the substrate surface via the linking agent upon reaction of the epoxy-reactive functionality with the epoxy group, the derivatization solution further comprising a base.

13. The method of claim 12, the hydrophobic ligand comprising an aliphatic chain with two or more carbons, a benzyl-containing group, a phenyl-containing group, a phenol-containing group, a pyridine-containing group, a boronic acid group, a branched polymer, a sulfur-containing thiophilic group, or any combination thereof.

14. The method of claim 12, the derivatization agent comprising thiophenol, 2-butanethiol, furfurylthiol, 6-mercaptopurine, 2-mercapto-benzothiazole, propanethiol, cyclopentanethiol, o-mercaptobenzoic acid, dithiothreitol, 1,2-ethanedithiol, 3,6-dioxa-1,8-octanedithiol, 1,4-benzenedimethanethiol, 1,3-benzenedimethanethio, 1,2-benzenedimethanethio, 4,4′-bis(mercaptomethyl)biphenyl, 2,4-dichlorobenzylmercaptan, 4-methoxybenzylmercaptan, triphenylmethanethiol, 2,4-dimethoxythiophenol, or any combination thereof.

15. The method of claim 12, the base of the derivatization solution comprising an alkanamine (e.g., methylamine, triethylamine, trimethylamine, tripropylamine, tributylamine, etc.), a pyridine, an imidazole, a benzimidazole, a histidine, a guanidine, a phosphazene base, N,N-dimethylbenzyl amine, 3-dimethylaminopropyl amine, N,N-diisopropylethylamine, N,N-dimethylene diamine, diethylamine, sodium amide, sodium hydroxide, sodium carbonate, sodium bicarbonate, potassium hydroxide, potassium carbonate, potassium bicarbonate, or any combination thereof.

16. The method of claim 12, the concentration of the derivatization agent in the derivatization solution being from about 0.01% (W/V) to about 5% (W/V) by volume of the derivatization solution, the concentration of the base in a derivatization solution being from about 0.01% (V/V) to about 99% (V/V) by volume of the derivatization solution.

17. The method of claim 12, the derivatization solution further comprising an organic solvent.

18. A hydrophobic interaction chromatography separation medium comprising a porous cellulose membrane and a plurality of a hydrophobic ligands bonded to a surface of the porous cellulose membrane, the porous cellulose membrane having a pore size of from about 0.1 micrometers to about 10 micrometers.

19. The hydrophobic interaction chromatography separation medium of claim 18, wherein the cellulose membrane comprises regenerated cellulose.

20. The hydrophobic interaction chromatography separation medium of claim 18, the medium comprising a plurality of the cellulose membrane stacked together, the stack having a thickness of from about 70 micrometers to about 10,000 micrometers.
